(19) United States
(12) Patent Application Publication
(10) Pub. No.: US 2016/0338388 A1
(43) Pub. Date: Nov. 24, 2016

(54) METHOD OF PAIRING FOODSTUFF WITH BEVERAGE AND PREPARED FOODSTUFF PREPARED THEREFROM

(71) Applicant: YNUTS, LLC, New York, NY (US)

(72) Inventors: David AVITAL, New York, NY (US); Pernilla AVITAL, New York, NY (US)

(73) Assignee: YNUTS, LLC, New York, NY (US)

(21) Appl. No.: 15/157,562

(22) Filed: May 18, 2016

Related U.S. Application Data
(60) Provisional application No. 62/163,033, filed on May 18, 2015.

(51) Int. Cl. C12H 1/14; C12G 1/00; C12G 3/00

(52) U.S. Cl. CPC A23L 1/364; C12G 1/00; C12G 3/00; A23V 2002/00

(57) ABSTRACT

The inventors of the present invention have discovered unexpectedly that it is possible to prepare ready-to-eat seasoned nut meals compatible with a designated beverage by pairing different grain and fruit derived alcohols together with a nut and a seasoning or combination of seasonings. The pairings are based on a number of factors, including flavor and taste, based on the chemical components comprised in the specific alcohol, nut, and seasoning.

### RELATED APPLICATIONS

This application claims benefit of U.S. Provisional Application No. 62/163,033, entitled “A Method of Pairing Foodstuff with Beverage and Prepared Foodstuff Prepared Therefrom” filed on May 18, 2015, which is herein incorporated by reference.

### BACKGROUND OF THE INVENTION

Mass produced foods have been both a boon and bane for society. Modern processes have enabled production of large quantities of food to be available at moderate costs for a large number of people. Additives to the food, such as flavoring, coloring, and preservative ingredients, both chemical and biologic have also increased shelf-life, appearance, texture, and palatability of the food.

Like other great contributions to society however, mass produced foods have also increased certain health risks with their consumption. Large quantities of food are processed at unethically high speeds for efficiency resulting in low safety standards, poor food quality, low cleanliness standards, toxins from cleaning chemicals and the machinery, and subsequently food poisoning outbreaks arise from the methods of food preparation in factories. Other consequences of mass produced food are the epidemic of obesity, death of children due to food borne illness and allergy contaminates, and the poor effect on the environment.

Nuts, both tree nuts and legumes, are a popular mass produced snack and small meal item. Nuts may be prepared for consumption a number of different ways, including roasting, dry-roasting, salting (with or without roasting), or boiling, to name a few.

In order to improve the flavor of nuts, they have long been roasted. Roasting is generally accomplished using either heated air or hot oil. Roasting is generally carried out at elevated temperatures by introducing nuts into a roasting oven, maintaining the heat or introducing heat to bring the nut up to a roasting temperature, e.g., 100° C.-200° C., and maintaining the heat at that temperature until the nuts reach proper taste and texture. Additionally, flavor of the roasted nuts can be further improved with the use of coatings and/or flavor oils.

For example, U.S. Pat. No. 4,161,545 discloses a method for applying a honey based coating to nuts. Similarly, U.S. Pat. No. 3,671,766 discloses a process for coating nuts with hexatol containing compositions. U.S. Pat. No. 4,053,650 discloses a method for coating nuts with cereal and wheat flour compositions which are baked onto the roasted nut. U.S. Pat. No. 4,085,230 discloses a process for processing nuts which includes an initial step of cooking the nuts in boiling water for a period of time before roasting. In a final coating step salt and flavoring are applied to the cooled nuts.

Nuts may also be blanched in addition to roasting and/or salting. Blanching is a process wherein the nut is plunged into boiling water, removed after a brief, timed interval, and finally plunged into iced water or placed under cold running water in order to halt the cooking process. U.S. Pat. No. 3,457,087, for example, discloses a method for eliminating “spotting” on nuts which is associated with blanching and roasting processes. The process involves the quenching of hot roasted nuts in copious amounts of cold oil which is said to be absorbed into the nut. Flavorings can be included in the quench oil.

During the initial part of a nut roasting process water is removed from the nut which generally has an initial moisture content of about 4% to 8% by weight. Until the water content is reduced to about 1.5% to 2.5% no browning or flavor development occurs. In addition to loss of water and other volatiles such as aromatics and air the cell structure expands and nut oil moves out of the nut kernel to its surface.

As a result of the loss of volatiles thermal expansion of the nut occurs, forming many small cracks and fissures in the nut. According to U.S. Pat. No. 3,457,087, at this point the nut should be capable of absorbing flavorings readily. However, flavoring added to the hot nuts are generally volatilized and only a minor amount, if any, remains to be absorbed by the nut. Once the nut has cooled the surface oil is absorbed, the nut contracts and the moisture content is equilibrated with the ambient conditions that is about 2% by weight moisture.

As a result of these physical phenomena of the nut during roasting and cooling, the prior art processes fail to impart substantial flavor to the nut itself. In the process of U.S. Pat. No. 3,457,087, for example, the cold oil is applied to hot nuts and as a consequence the flavoring is volatilized in the region immediately adjacent to the nut. There has been a failure in the prior art to recognize that nut surface temperature during the application of flavorings to nuts is critical if the flavoring is to be absorbed rather than remain merely as a surface coating.

While traditional roasting and/or salting or coating methods add flavor to nuts, there are considerable drawbacks associated therewith. It's long been understood that our experience of food is a complex story and involves all five senses. Even though sight, which includes mostly the impact of color or presentation of food, and hearing, which includes most notably the expectation of crunchiness, affect our perception, while taste, touch, and smell make up the main ingredients of taste. Through our sense of smell we are able to differentiate up to 10,000 different odors. Odors are also known as smells, scents or fragrances and consist of one or more aroma molecules. Aroma molecules, also known as flavor, are chemical compounds which have a smell or odor and are sufficiently volatile to be transported to the olfactory system in the upper part of the nose. Generally molecules meeting this specification have molecular weights of less than 300 g/mol. Aroma compounds can be found in food, wine, spices, perfumes, fragrance oils, and essential oils. For example, many form biochemically during ripening of fruits and other crops. In wines, most form as byproducts of fermentation.

The use of an aroma profile is used to pair foods in a process known as Foodpairing®, which is disclosed at www.foodpairing.com. Foodpairing® basically determines what molecules contribute to a food's aroma to determine an aroma profile of a specific ingredient through gas chromatography coupled mass spectrometry (GC-MS). When different foods share certain key aromas they are more likely to pair well in a recipe. From these results, Foodpairing® extract the aroma data relevant to the human sense of smell, and identifies which ingredients combine well based on their aromas. Ingredients match when they have aroma molecules in common.

Despite these useful methods of pairing foodstuff with beverages, there remains a strong need for better methods and more detailed analytics for achieving food pairings. Relying solely on aroma leaves much to be desired in pairing food together, since taste, texture, acidity, alcohol content, organoleptic qualities, and a myriad of other factors contribute to the success of such pairings.

### SUMMARY

Provided therefore herein, is a method of mating a seasoned foodstuff with a beverage to make a ready-to-eat seasoned foodstuff. The method includes: i) Identifying taste elements and aroma elements of a beverage to form a beverage elements list, ii) identifying taste elements and aroma elements of a nut to form a nut elements list, iii) identifying taste elements and aroma elements of a seasoning to form a seasoning elements list, iv) Mating the beverage with the nut and the seasoning to form a synergistic organoleptic combination, and v) preparing the seasoned foodstuff based on the combination.

In an embodiment the seasoned foodstuff is prepared using a nut which is a natural oven roasted nut. In an embodiment, the nut is selected from the group of almonds, walnuts, pecans, hazelnuts, and pistachios. In an embodiment, the seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

In another embodiment, beverage is an alcoholic beverage. In another embodiment, the beverage is selected from wine, gin, vodka, whiskey, bourbon, beer, and tequila. In an embodiment, the wine is selected from the group of reds, whites, and sparkling wines. In another embodiment, the wine is selected from pinot noir, cabernet sauvignon, merlot, pinot grigio, fiano, chardonnay, sauvignon blanc, and combinations thereof.

In an embodiment, the method further includes the step of identifying additional factors in the beverage, the nut, and the seasoning to enhance compatibility of the seasoned foodstuff with the beverage.

In yet another embodiment, the present invention includes a ready-to-eat seasoned foodstuff mated for consumption with a designated beverage. The foodstuff includes a nut chosen based on identification of taste elements and aroma elements therein, a seasoning at least partially coating the nut, the seasoning chosen based on identification of taste elements and aroma elements therein; the nut and seasoning selected to combine with a designated beverage to form a synergistic organoleptic experience.

In another embodiment, the nut in the ready-to-eat seasoned foodstuff is a natural oven roasted nut. In an embodiment, the nut is selected from the group of almonds, walnuts, pecans, hazelnuts, and pistachios. In yet another embodiment, the seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

In another embodiment, the beverage of the ready-to-eat seasoned foodstuff is an alcoholic beverage. In an embodiment the beverage is selected from wine, gin, vodka, whiskey, bourbon, beer, and tequila. In another embodiment, the wine is selected from the group of reds, whites, and sparkling wines. In yet another embodiment, the wine is selected from pinot noir, cabernet sauvignon, merlot, pinot grigio, fiano, chardonnay, sauvignon blanc, and combinations thereof.

In another embodiment, the ready-to-eat foodstuff is a combination of a roasted walnut and said beverage is gin. In another embodiment the combination is roasted pecan and said beverage is whiskey. In yet another embodiment, the combination is roasted hazelnut and said beverage is brandy. In another combination roasted almond is paired with pinot noir. In another embodiment, the combination is roasted almond and pinot noir. In another embodiment, the combination is roasted pecan and fiano. In yet another embodiment, the combination is roasted almond and vodka.

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### DETAILED DESCRIPTION

The inventors of the present invention have discovered unexpectedly that it is possible to prepare ready-to-eat seasoned nut meals compatible with a designated beverage by pairing different grain and fruit derived alcohols together with a nut and a seasoning. The pairings are based on a number of factors, including flavor and taste, based on the chemical components comprised in the specific alcohol. Using proven scientific procedures, the flavor components and different sensations in each type of alcohol can be broken down and then utilized to season nuts to accompany the different selected alcohols.

As used herein, the term “nut” refers to any kernel found within a shell, and generally used in food, and includes both tree nuts and legumes. A nut is generally known as any hard-walled edible kernel which is typically a fruit composed of a hard shell and a seed, and is generally edible. Some examples of nuts include, without limitation, almonds, peanuts, hazelnuts, chestnuts, acorns, pecans, pistachios, walnuts, Brazil nuts, candlenut, cashews, macadamia, mongono, pine nut, walnut, and Yeheb nut.

As used herein the term “seasoned,” “seasoning,” or “season(s)” refers to any salt, herbs, spices, fruits, cheeses, oils, yerba mate, or any other ingredients used to enhance the overall organoleptic qualities of the ready-to-eat seasoned foodstuff. Some examples include, but are not limited to grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

As used herein the term “flavor” or “flavor element” refers to aroma molecules, also known as flavors, which are chemical compounds that have a smell or odor and are sufficiently volatile to be transported to the olfactory system in the upper part of the nose. Generally molecules meeting this specification have molecular weights of less than 300 g/mol. Aroma compounds can be found in food, wine, spices, perfumes, fragrance oils, and essential oils.

As used herein the term “taste” or “taste element” refers to gustatory perception, or gustation, and is an element which contributes to the sensory impression of food or other substances on the tongue. The sensation of taste can be categorized into five basic tastes: sweetness, sourness, saltiness, bitterness, and umami. Taste buds are able to differentiate among different tastes through detecting interaction with different molecules or ions. Sweet, umami, and bitter tastes are triggered by the binding of molecules to G protein-coupled receptors on the cell membranes of taste buds. Saltiness and sourness are perceived when alkali metal or hydrogen ions enter taste buds, respectively.

As used herein the term “organoleptic” refers to properties of a food relating to the overall experience, including a sum of all aspects of taste, flavor, sight, smell, touch, dryness, texture, moisture, stale-fresh factors, and all other factors as experienced by the senses. It also can refer to factors, such as those detected through a variety of mechanoreceptors, muscle nerves, etc.; temperature, detected by thermoreceptors; and “coolness” (such as of menthol) and “hotness” (pungency), through chemesthesis.

As used herein the term, “natural oven roasted nut” refers to a roasting process utilizing natural methods, including stone roasting (e.g., soapstone, slate, or lava rocks), charcoal roasting, or other natural roasting processes. Such roasting methods are disclosed in concurrently filed applications, Ser. No. 15/091,645, the entirety of which is herein incorporated by reference.

In an embodiment, when the terms “natural flavorant or natural adhesive” is used herein, it is contemplated that either the natural flavorant or the natural adhesive may have at least 0.5% yerba mate by weight of either or both of said natural flavorant or natural adhesive. Preferably it would contain more yerba mate; anywhere up to and including 100% of said natural flavorant or adhesive.

Scientific, analytical testing can determine the chemical makeup of different alcohols. Paying specific attention to flavor elements and taste elements that contribute towards taste and overall organoleptic properties of a foodstuff, a new ready-to-eat seasoned nut product will contain an overall organoleptic composition congruent with grain and fruit alcohols. By using specific seasonings to complement and counteract characteristics of alcohol based on desirability, the seasoned nuts will modulate the perceived intensities and levels of acidity, bitterness, astringency, fruitiness, sweetness, tannins, metallic taste, phenolic flavor, alcoholicity, carbonation, caramel-like notes, licorice-like notes, and burnt notes. By seasoning nuts based on science and nutritional values, an enjoyable experience of a snack made specifically to complement various alcoholic beverages is created.

A list of the elements in selected types of grain and fruit alcohol will be categorized after extensive chemical tests reveal the composition. One commonly used and accurate method to determine the chemical breakdown of alcohol is gas chromatography. In this method, the components of a sample of alcohol are dissolved in a solvent and vaporized into a gas state of matter in order to identify every element. Once the elements are discovered and categorized, use of a method will fully analyze the flavor elements to determine which can complement specific seasonings to flavor the nuts. Alcoholic beverages contain flavor compounds such as aliphatic carbonyl compounds, alcohols, monocarboxylic acids, nitrogen, sulphur compounds, hydrocarbons, terpenic compounds, heterocyclic and aromatic compounds, unfermented sugars, dibasic and tribasic carboxylic acids, coloring substances, tannic and polyphenolic substances, and inorganic salts. The nuts will also be seasoned based on these different flavor compounds and other characteristics of the alcohol to adjust how one might perceive the intensities. For example, the fatty acids in a cheese seasoning, by coating taste receptors, would reduce the intensity of wine acids and phenolics. The combination of eating the flavored nut product and drinking the matching alcohol will create an enhanced experience of complementing tastes and aromas.

All foods contain flavor compounds. For example, the aroma of banana/pear is the compound isoamyl acetate. Flavor pairing is matching foods together that have the same flavor compounds. Our senses are not limited to flavors however, and we can also sense taste. Taste is a little less-defined, and involves the texture of different molecules on our palates. Taste pairing generally balances the 6 tastes of salt, sweet, acid, fat, bitter, and umami.

It is also a challenge to provide a truly pleasurable organoleptic experience in a ready-to-eat prepackaged meal, particularly mating such a ready-to-eat meal with a beverage. Such ready-to-eat foodstuff mated with an alcohol beverage would be very attractive for sale and consumption by, for example, travelers and in airports, train and bus terminals where a ready-to-eat foodstuff featuring an natural oven-roasted nut would provide protein and over-all nutrition, while also being enjoyably mated with an alcoholic beverage of choice for the traveler. The pre-packaged, ready-to-eat foodstuff would also be easily transported and stored by transporters and vendors, since they do not require refrigeration and/or are not perishable.

Aromatic compounds are vital in the biochemistry of life. The four aromatic amino acids histidine, phenylalanine, tryptophan, and tyrosine individually are one of the 20 essential building-blocks of proteins. Aromatic compounds are made up of aromatic molecules or aroma molecules which are comprised of covalently bonded atoms. Each aroma molecule activates a specific receptor on the nasal mucosa. The receptor can be activated by even just a few aroma molecules. However, odors consist of many molecules, not just a handful, which explains why humans can sense approximately 10,000 aromas. Because of the influx of aromas, smell accounts for approximately 80% of the entire taste experience. This helps explain why we are so immediately sensitive to odors, and why flavor and aroma are inextricably tied together, distinguishing aroma molecules as most crucial in the outcome of taste.

Alcoholic beverages contain flavor compounds: aliphatic carbonyl compounds, alcohols, monocarboxylic acids, nitrogen, sulphur compounds, hydrocarbons, terpenic compounds, heterocyclic and aromatic compounds, unfermented sugars, dibasic and tribasic carboxylic acids, coloring substances, tannic and polyphenolic substances, and inorganic salts.

Nuts are an ideal choice for use in the ready-to-eat seasoned foodstuff of the present invention since nuts easily retain freshness, and other favorable organoleptic qualities in such a ready-to-eat package with minimum care in transport and storage as noted above.

The process of the invention can be applied to any of those edible nut varieties, including tree and ground nuts, which are conventionally packaged and sold as snack-type products. Illustrative of such nut meats are peanuts, cashews, almonds, walnuts, filberts, macadamia nuts, pecans, and the like.

The nuts may be deshelled in a preliminary step and, optionally are also subjected to other conventional procedures such as blanching and the like, prior to being subjected to the process of the invention. When the nuts are ready to be roasted, they are subjected to roasting under conditions which may vary depending upon the particular type of raw nut and the type of roasting process, be it oil or air (i.e., dry) roasting. Illustratively, the nuts are roasted at temperatures within the range of from about 200° F. to about 450° F., for a time which will vary depending upon the particular roasting temperature employed, the particular type of nut being processed, and the degree of roasting desired. For example, the time and extent of roasting will be greater in the case of peanuts than in the case of cashews. The most appropriate roasting conditions to be adopted in any particular instance can be determined readily by a process of trial and error.

The roasting operation can be conducted on a batch or continuous basis. The residence time of the nuts in the oven is adjusted to provide the desired time of roasting; e.g., a range of about one minute to about 20 minutes. Any of the apparatuses conventionally employed in the art to effect the dry roasting of nuts can be utilized in the above batch or continuous roasting step. It is an advantage of the present invention that superior results are achieved when air roasting nuts coated in the manner described above.

An adhesive and/or a flavorant may also be used in the method of the present invention. Adhesives are well known in the art. Illustrative of suitable adhesive materials are those synthetic and derived vegetable gums such as xanthan, arabic, and guar, as well as dextrins, modified starches, and the like. Other optional ingredients to control viscosity and tackiness, including proteinaceous materials such as albuminoids, e.g., gelatin, albumins, glutenous materials, and like agents, can be present in the adhesive solution. The dry adhesive predust can employ any of these materials, preferably a dextrin or pregelatinized starch. The gelatin and like thickening/adhesive agents, are preferably employed in lesser amounts than the gums, and at levels up to about five percent by weight. In a preferred embodiment, a natural adhesive may be used, such as Yerba Mate. The use of this adhesive is disclosed in application number 2481-9P, filed on even date herewith, and incorporated by reference herein.

The use of yerba mate herb is a healthier and organic method of adhering salt to roasted nuts with the added benefit of energy boosting properties and general, potential health benefits like pain relief and weight loss. Using the yerba mate herb avoids a need for extra fat in oil or butter, extra salt in a brine solution, or a processed sugar-based “gum” like xanthan gum as an adhesive.

As used herein, the term “yerba mate” or “mate” refers to the plant yerba mate, and anything derived therefrom. Yerba mate is a species of the holly family (Aquifoliaceae), with the botanical name Ilex paraguariensis. It is contemplated within the invention that other components known in the art may be combined with yerba mate to be used as an adhesive. Alternatively, yerba mate may also be used as a seasoning, or additive, and not for its adhesive functionality.

The nuts disclosed herein can also optionally be coated with additional flavorants or seasoning. Some examples include, non-exhaustively, allspice, anise, basil, beau monde seasoning salt, caraway, cardamom, pepper, chives, cilantro, five spice Chinese powder, garlic, ginger, juniper berries, mace, marjoram, mei yen seasoning, mint, mustard, nutmeg, oregano, paprika, parsley, pine nuts, poppyseed, pumpkin pie spice, rosemary, saffron, sage, savory, salt, sea salt, sesame seeds, shallot, soy sauce, tabasco, tarragon, thyme, turmeric, worcestershire sauce, and zest.

In another embodiment, the nut may have a coating, which may be a hard or soft coating, such as chocolate and/or candy shell. Such coatings are well known in the art to confectioners. In another embodiment, the seasoning and the natural adhesive are mixed together to form a seasoned adhesive prior to at least partially coating the nut. In an embodiment, the seasoning and the natural adhesive are mixed in a ratio of from about 1/20 of adhesive/salt to about 1/5 of adhesive/salt.

### EXAMPLES

The present invention is further exemplified, but not limited, by the following representative examples, which are intended to illustrate the invention and are not to be construed as being limitations thereto.

### Example 1

Pairing gin together with roasted walnuts that are flavored based on the chemical components and aroma molecules comprised in gin, walnuts, and the chosen flavor ingredients. Using proven scientific procedures, the flavor components and different sensations in gin can be broken down and then utilized to season walnuts to accompany gin beverages specifically.

A list of the elements in gin will be categorized after extensive chemical tests reveal the full scientific composition. One commonly used and accurate method to determine the chemical breakdown of alcohol is gas chromatography. In this method, the components of a sample of gin are dissolved in a solvent and vaporized into a gas state of matter in order to identify every element. Once the elements are discovered and categorized, use of a proprietary method will fully analyze the flavor elements, aroma molecules and taste elements to determine which can complement roasted walnuts and specific seasonings to flavor the walnuts. The walnuts and the seasonings can also be analyzed using gas chromatography when in tandem with mass spectrometry which is used to discover and categorize the chemical composition from the element's mass spectra. After the flavor elements and taste elements of the roasted walnuts and various seasonings are categorized, seasonings can be determined. A good combination for gin and roasted walnuts would be roasted walnuts flavored with grapefruit and lemongrass. Since gin shares aroma molecules with roasted walnuts, grapefruit, and lemongrass. The walnuts will also be seasoned based on these different flavor compounds and other characteristics of the gin to adjust how one might perceive the intensities. For example, the citric acid in the fresh grapefruit, by coating taste receptors, would reduce the intensity of phenolics. The science behind the aroma molecules proves that the sweet and sour taste of the grapefruit and lemongrass combination decreases the intensity of gin's “bite”. The combination of eating the grapefruit and lemongrass flavored walnut product and drinking gin or a gin beverage will create an enhanced experience of complementing aromas and tastes.

Roasted walnuts that are seasoned based on the chemical components and flavor characteristics of gin, will transform ordinary dining into a full flavor experience. By implementing the science of aroma molecules and taste elements, and by changing the perception of flavors using a combination of enhancing the desirable qualities and suppressing the unpleasant characteristics of gin, the roasted walnuts flavored with lemongrass and grapefruit will create a synergy of taste when paired with gin.

### Example 2

Pairing whiskey together with roasted pecans that are flavored based on the chemical components comprised in whiskey, pecans, and the chosen flavor ingredients. Using proven scientific procedures, the flavor components and different sensations in whiskey can be broken down and then utilized to season pecans to accompany whiskey beverages specifically.

Scientific, analytical testing can determine the chemical makeup of whiskey. Paying specific attention to elements that contribute towards taste and aroma molecules, the new roasted pecan product will be seasoned to contain congruent flavor composition in the whiskey. By using specific seasonings to complement and counteract characteristics of whiskey based on desirability, the seasoned pecans will modulate the perceived intensities and levels of acidity, bitterness, astringency, fruitiness, sweetness, metallic taste, phenolic flavor, and alcoholicity. By seasoning pecans based on science and nutritional values, an enjoyable experience of a snack made specifically to complement various whiskey beverages is created: roasted pecans coated with the juice and rind from fresh mandarin oranges and seasoned with a blend of nutmeg and cinnamon.

A list of the elements in whiskey will be categorized after extensive chemical tests reveal the full scientific composition. One commonly used and accurate method to determine the chemical breakdown of alcohol is gas chromatography. In this method, the components of a sample of whiskey are dissolved in a solvent and vaporized into a gas state of matter in order to identify every element. Once the elements are discovered and categorized, use of a method will fully analyze the flavor elements and aroma molecules to determine which can complement roasted pecans and specific seasonings to flavor the pecans. The pecans and the seasonings can also be analyzed using gas chromatography when in tandem with mass spectrometry which is used to discover and categorize the chemical composition from the element's mass spectra. After the flavor elements, taste elements, and aroma molecules of the roasted pecans and various seasonings are categorized, seasonings can be determined. A good combination for whiskey and roasted pecans would be roasted pecans coated with the juice and rind from mandarin oranges and seasoned with a blend of nutmeg and cinnamon. Since whiskey shares aroma molecules with nutmeg, and nutmeg shares aroma molecules with roasted pecans, mandarin orange, and cinnamon. The pecans will also be seasoned based on these different flavor compounds and other characteristics of the whiskey to adjust how one might perceive the intensities. For example, the citric acid in the fresh mandarin orange, by coating taste receptors, would reduce the intensity of phenolics. The science behind the aroma molecules proves that the sweet and sour taste of the mandarin orange with the pungent nutmeg and cinnamon combination decrease the intensity of whiskey's “bite”. The combination of eating the spiced mandarin orange flavored pecan product and drinking whiskey or a whiskey beverage will create an enhanced experience of complementing aromas and tastes.

Roasted pecans that are seasoned based on the chemical components and flavor characteristics of whiskey, will transform ordinary dining into a full flavor experience. By implementing the science of aroma molecules, taste elements, and flavor elements, and by changing the perception of flavors using a combination of enhancing the desirable qualities and suppressing the unpleasant characteristics of whiskey, the roasted pecans flavored with nutmeg, cinnamon, and mandarin orange will create a synergy of taste when paired with whiskey.

### Example 3

Pairing brandy together with roasted hazelnuts that are flavored based on the chemical components and aroma and taste molecules comprised in brandy, hazelnuts, and the chosen flavor ingredients. Using proven scientific procedures, the flavor components and different sensations in brandy can be broken down and then utilized to season hazelnuts to accompany brandy beverages specifically.

Scientific, analytical testing can determine the chemical makeup of brandy. Paying specific attention to elements that contribute towards taste like aroma and taste molecules, the new roasted hazelnut product will be seasoned to contain congruent flavor composition in the brandy. By using specific seasonings to complement and counteract characteristics of brandy based on desirability, the seasoned hazelnuts will modulate the perceived intensities and levels of acidity, bitterness, astringency, fruitiness, sweetness, metallic taste, phenolic flavor, and alcoholicity. By seasoning hazelnuts based on science and nutritional values, an enjoyable experience of a snack made specifically to complement various brandy beverages is created: roasted hazelnuts flavored with coffee and Tahitian vanilla and seasoned with cloves.

A list of the elements in brandy will be categorized after extensive chemical tests reveal the full scientific composition. One commonly used and accurate method to determine the chemical breakdown of alcohol is gas chromatography. In this method, the components of a sample of brandy are dissolved in a solvent and vaporized into a gas state of matter in order to identify every element. Once the elements are discovered and categorized, use of a method will fully analyze the flavor elements, taste elements, and aroma molecules to determine which can complement roasted hazelnuts and specific seasonings to flavor the hazelnuts. The hazelnuts and the seasonings can also be analyzed using gas chromatography when in tandem with mass spectrometry which is used to discover and categorize the chemical composition from the element's mass spectra. After the flavor elements and aroma molecules of the roasted hazelnuts and various seasonings are categorized, seasonings can be determined. A good combination for brandy and roasted hazelnuts would be roasted hazelnuts flavored with coffee and Tahitian vanilla and seasoned with cloves. Since brandy shares aroma molecules with roasted hazelnuts, Tahitian vanilla, and cloves. The hazelnuts will also be seasoned based on these different flavor compounds and other characteristics of the brandy to adjust how one might perceive the intensities. For example, the vanillin in the Tahitian vanilla, by coating taste receptors, would reduce the intensity of phenolics. The science behind the aroma molecules proves that the sweetness of the vanilla with the pungency of the coffee and the cloves decreases the intensity of brandy's “bite”. The combination of eating the coffee, Tahitian vanilla, and cloves flavored hazelnut product and drinking brandy or a brandy beverage will create an enhanced experience of complementing aromas and tastes.

Roasted hazelnuts that are seasoned based on the chemical components and flavor characteristics of brandy, will transform ordinary dining into a full flavor experience. By implementing the science of aroma molecules, taste elements, and flavor elements, and by changing the perception of flavors using a combination of enhancing the desirable qualities and suppressing the unpleasant characteristics of brandy, the roasted hazelnuts flavored with Tahitian vanilla, coffee, and seasoned with cloves will create a synergy of taste when paired with brandy.

### Example 4

Pairing pinot noir together with roasted almonds that are flavored based on the chemical components comprised in pinot noir specifically. Using proven scientific procedures, the flavor components and different sensations in each type of alcohol can be broken down and then utilized to season roasted almonds to accompany the pinot noir.

Scientific, analytical testing can determine the chemical makeup of different alcohols. Paying specific attention to elements that contribute towards taste like taste and aroma molecules, the new almond product will be seasoned to contain congruent flavor composition in the grain and fruit alcohols. By using specific seasonings to complement and counteract characteristics of alcohol based on desirability, the seasoned and roasted almonds will modulate the perceived intensities and levels of acidity, bitterness, astringency, fruitiness, sweetness, tannins, metallic taste, phenolic flavor, and alcoholicity. By seasoning roasted almonds based on science and nutritional values, an enjoyable experience of a snack made specifically to complement pinot noir is created: roasted almonds flavored with buckwheat honey, fresh meeker raspberries, and ginger.

A list of the elements in pinot noir will be categorized after extensive chemical tests reveal the full scientific composition. One commonly used and accurate method to determine the chemical breakdown of alcohol is gas chromatography. In this method, the components of a sample of pinot noir are dissolved in a solvent and vaporized into a gas state of matter in order to identify every element. Once the elements are discovered and categorized, use of a method will fully analyze the flavor elements and aroma molecules to determine which can complement specific seasonings to flavor the roasted almonds. The almonds and the seasonings can also be analyzed using gas chromatography when in tandem with mass spectrometry which is used to discover and categorize the chemical composition from the element's mass spectra. After the flavor elements and taste elements, including aroma molecules of the roasted almonds and various seasonings are categorized, seasonings can be determined. A good combination for pinot noir and roasted almonds would be roasted almonds flavored with buckwheat honey, fresh meeker raspberries, and ginger. Since pinot noir shares aroma molecules with roasted almonds, buckwheat honey, meeker raspberries, and ginger. The almonds will also be seasoned based on these different flavor compounds and other characteristics of the alcohol to adjust how one might perceive the intensities. For example, the monosaccharides fructose and glucose in honey, by coating taste receptors, would reduce the intensity of wine acids and phenolics. The science behind the aroma molecules proves that the sweet and sour taste of the meeker raspberries and buckwheat honey with the sharp ginger together decrease the intensity of the tannins in pinot noir. The combination of eating the flavored roasted almond product and drinking the pinot noir will create an enhanced experience of complementing tastes and aromas.

Roasted almonds that are seasoned based on the chemical components and flavor characteristics of pinot noir, will transform ordinary dining into a full flavor experience. By implementing the science of aroma molecules and flavor elements, and by changing the perception of flavors using a combination of enhancing the desirable qualities and suppressing the unpleasant characteristics of pinot noir, the roasted almonds flavored with buckwheat honey, raspberries, and ginger will create a synergy of taste when paired with pinot noir.

### Example 5

Pairing fiano together with roasted pecans that are flavored based on the chemical components comprised in fiano specifically. Using proven scientific procedures, the flavor components and different sensations in each type of alcohol can be broken down and then utilized to season roasted pecans to accompany the fiano.

Scientific, analytical testing can determine the chemical makeup of different alcohols. Paying specific attention to taste and flavor elements that contribute towards taste like aroma molecules, the new pecan product will be seasoned to contain congruent flavor composition in the grain and fruit alcohols. By using specific seasonings to complement and counteract characteristics of alcohol based on desirability, the seasoned and roasted pecans will modulate the perceived intensities and levels of acidity, bitterness, astringency, fruitiness, sweetness, tannins, metallic taste, phenolic flavor, and alcoholicity. By seasoning roasted pecans based on science and nutritional values, an enjoyable experience of a snack made specifically to complement fiano is created: roasted pecans flavored with lemon zest, kumquat peel, basil, and rosemary.

A list of the elements in fiano will be categorized after extensive chemical tests reveal the full scientific composition. One commonly used and accurate method to determine the chemical breakdown of alcohol is gas chromatography. In this method, the components of a sample of fiano are dissolved in a solvent and vaporized into a gas state of matter in order to identify every element. Once the elements are discovered and categorized, use of a proprietary method will fully analyze the flavor elements and aroma molecules to determine which can complement specific seasonings to flavor the roasted pecans. The pecans and the seasonings can also be analyzed using gas chromatography when in tandem with mass spectrometry which is used to discover and categorize the chemical composition from the element's mass spectra. After the flavor elements and aroma molecules of the roasted pecans and various seasonings are categorized, seasonings can be determined. A good combination for fiano and roasted pecans would be roasted pecans flavored with lemon zest, kumquat peel, basil, and rosemary. Since fiano shares aroma molecules with roasted pecans, buckwheat honey, meeker raspberries, and ginger. The pecans will also be seasoned based on these different flavor compounds and other characteristics of fiano wine to adjust how one might perceive the intensities. For example, the citric acid in lemon zest or rind, by coating taste receptors, would reduce the intensity of wine acids and phenolics. The science behind the aroma molecules proves that the sweet and sour taste of the lemon zest and kumquat peel with the pungent basil and rosemary together decrease the intensity of the tannins in fiano. The combination of eating the flavored roasted pecan product and drinking the fiano will create an enhanced experience of complementing tastes and aromas.

Roasted pecans that are seasoned based on the chemical components and flavor characteristics of fiano, will transform ordinary dining into a full flavor experience. By implementing the science of taste and aroma molecules and flavor elements, and by changing the perception of flavors using a combination of enhancing the desirable qualities and suppressing the unpleasant characteristics of fiano, the roasted pecans flavored with lemon zest and kumquat peel then seasoned with basil and rosemary will create a synergy of taste when paired with fiano.

### Example 6

Pairing vodka together with roasted almonds that are flavored based on the chemical components and taste and aroma molecules comprised in vodka, almonds, and the chosen flavor ingredients. Using proven scientific procedures, the flavor components and different sensations in vodka can be broken down and then utilized to season almonds to accompany vodka beverages specifically.

Scientific, analytical testing can determine the chemical makeup of vodka. Paying specific attention to elements that contribute towards taste like taste and aroma molecules, the new roasted almond product will be seasoned to contain congruent flavor composition in the vodka. By using specific seasonings to complement and counteract characteristics of vodka based on desirability, the seasoned almonds will modulate the perceived intensities and levels of acidity, bitterness, astringency, fruitiness, sweetness, metallic taste, phenolic flavor, and alcoholicity. By seasoning almonds based on science and nutritional values, an enjoyable experience of a snack made specifically to complement various vodka beverages is created: roasted almonds infused with apple wood smoke, and flavored with sharp cheddar cheese and Granny Smith apples.

A list of the elements in vodka will be categorized after extensive chemical tests reveal the full scientific composition. One commonly used and accurate method to determine the chemical breakdown of alcohol is gas chromatography. In this method, the components of a sample of vodka are dissolved in a solvent and vaporized into a gas state of matter in order to identify every element. Once the elements are discovered and categorized, use of a method will fully analyze the flavor elements and aroma molecules to determine which can complement roasted almonds and specific seasonings to flavor the almonds. The almonds and the seasonings can also be analyzed using gas chromatography when in tandem with mass spectrometry which is used to discover and categorize the chemical composition from the element's mass spectra. After the flavor and taste elements and aroma molecules of the roasted almonds and various seasonings are categorized, seasonings can be determined. A good combination for vodka and roasted almonds would be roasted almonds infused with apple wood smoke, and flavored with sharp cheddar cheese and Granny Smith apples. Since vodka shares aroma molecules with sharp cheddar cheese and Granny Smith apples, and sharp cheddar cheese shares aroma molecules with roasted almonds and apple wood smoke. The almonds will also be seasoned based on these different flavor compounds and other characteristics of the vodka to adjust how one might perceive the intensities. For example, the fatty acids in the sharp cheddar cheese seasoning, by coating taste receptors, would reduce the intensity of phenolics. The science behind the aroma molecules proves that the sour taste of the Granny Smith apple with the sharpness and cheesiness of the cheddar will decrease the intensity of vodka's “bite”. The combination of eating the cheddar and apple flavored almond product and drinking vodka or a vodka beverage will create an enhanced experience of complementing aromas and tastes.

Roasted almonds that are seasoned based on the chemical components and flavor characteristics of vodka, will transform ordinary dining into a full flavor experience. By implementing the science of aroma molecules and flavor elements, and by changing the perception of flavors using a combination of enhancing the desirable qualities and suppressing the unpleasant characteristics of vodka, the roasted almonds flavored with sharp cheddar cheese and apple, and with an infusion of apple wood smoke will create a synergy of taste when paired with vodka.

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed is:

1. A method of mating a seasoned foodstuff with a beverage to make a ready-to-eat seasoned foodstuff comprising:
i) Identifying taste elements and aroma elements of a beverage to form a beverage elements list;
ii) Identifying taste elements and aroma elements of a nut to form a nut elements list;
iii) Identifying taste elements and aroma elements of a seasoning to form a seasoning elements list;
iv) Mating said beverage with said nut and said seasoning to form a synergistic organoleptic combination;
v) Preparing said seasoned foodstuff based on said combination.

2. The method according to claim 1 wherein said nut is a natural oven roasted nut.

3. The method according to claim 1 wherein said nut is selected from the group of almonds, walnuts, pecans, hazelnuts, and pistachios.

4. The method according to claim 1 wherein said seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

5. The method according to claim 1 wherein said beverage is an alcoholic beverage.

6. The method according to claim 5 wherein said beverage is selected from wine, gin, vodka, whiskey, bourbon, beer, and tequila.

7. The method according to claim 6 wherein said wine is selected from the group of reds, whites, and sparkling wines.

8. The method of claim 7 wherein said wine is selected from pinot noir, cabernet sauvignon, merlot, pinot grigio, fiano, chardonnay, sauvignon blanc, and combinations thereof.

9. The method of claim 1 further comprising the step of identifying additional factors in said beverage, said nut, and said seasoning to enhance compatibility of said seasoned foodstuff with said beverage.

10. A ready-to-eat seasoned foodstuff mated for consumption with a designated beverage, comprising:
i) A nut chosen based on identification of taste elements and aroma elements therein;
ii) A seasoning at least partially coating said nut, said seasoning chosen based on identification of taste elements and aroma elements therein;
said nut and seasoning selected to combine with a designated beverage to form a synergistic organoleptic experience.

11. The ready-to-eat seasoned foodstuff of claim 10 wherein said nut is a natural oven roasted nut.

12. The ready-to-eat seasoned foodstuff of claim 10 wherein said nut is selected from the group of almonds, walnuts, pecans, hazelnuts, and pistachios.

13. The ready-to-eat seasoned foodstuff of claim 10 wherein said seasoning is selected from grapefruit juice, lemongrass juice, rind from fresh mandarin oranges, nutmeg, cinnamon, coffee, Tahitian vanilla, cloves, buckwheat honey, raspberries, ginger, basil, rosemary, cheddar, apple, and mixtures thereof.

14. The ready-to-eat seasoned foodstuff of claim 10 wherein said beverage is an alcoholic beverage.

15. The ready-to-eat seasoned foodstuff of claim 14 wherein said beverage is selected from wine, gin, vodka, whiskey, bourbon, beer, and tequila.

16. The ready-to-eat seasoned foodstuff of claim 15 wherein said wine is selected from the group of reds, whites, and sparkling wines.

17. The ready-to-eat seasoned foodstuff of claim 16 wherein said sine is selected from pinot noir, cabernet sauvignon, merlot, pinot grigio, fiano, chardonnay, sauvignon blanc, and combinations thereof.

18. The ready-to-eat seasoned foodstuff of claim 10 wherein said seasoned foodstuff is a roasted walnut and said beverage is gin.

19. The ready-to-eat seasoned foodstuff of claim 10 wherein said seasoned foodstuff is roasted pecan and said beverage is whiskey.

20. The ready-to-eat seasoned foodstuff of claim 10 wherein said seasoned foodstuff is roasted hazelnut and said beverage is brandy.

21. The ready-to-eat seasoned foodstuff of claim 10 wherein said seasoned foodstuff is roasted almond and said beverage is pinot noir.

22. The ready-to-eat seasoned foodstuff of claim 10 wherein said seasoned foodstuff is roasted pecan and said beverage is fiano.

23. The ready-to-eat seasoned foodstuff of claim 10 wherein said seasoned foodstuff is roasted almond and said beverage is vodka.
